(19) United States
(12) Patent Application Publication
(10) Pub. No.: US 2003/0077516 A1
(43) Pub. Date: Apr. 24, 2003

(54) Cell incorporating polymer electrolyte

(76) Inventors: William James Macklin, Oxfordshire (GB); Christine Ruth Jarvis, Oxfordshire (GB)

Correspondence Address: Law Offices of William H Holt, Unit 2 First Floor, 1423 Powhatan Street, Alexandria, VA, 22314, US

(21) Appl. No.: 10/220,568

(22) PCT Filed: Feb. 21, 2001
(86) PCT No.: PCT/GB01/00709

(51) Int. Cl. H01M 2/16; H01M 4/58; H01M 10/04; H01M 2/02; H01M 10/40

(52) U.S. Cl. 429/254; 429/316; 429/127; 429/231.95; 429/162; 29/623.5

(57) ABSTRACT

An electrochemical cell is made by assembling an anodic layer and a cathodic layer, these layers being separated by a plasticised membrane of polymeric material consisting of a PVdF-type polymer chain, and ethylene carbonate as a plasticiser, but containing no lithium salt, the membrane being less than 30 μm thick and being cast from a volatile solvent. The resulting cell precursor is soaked in an electrolyte solution to form the cell. The membrane absorbs the electrolyte solution, forming a gelled or polymeric electrolyte.

This invention relates to an electrochemical cell incorporating a polymer electrolyte, and to a method of making such an electrochemical cell.

For many years it has been known to make rechargeable cells with lithium metal anodes, and cathodes of a material into which lithium ions can be intercalated or inserted. Such cells may use a separator such as filter paper or polypropylene saturated with, as electrolyte, a solution of a lithium salt in an organic liquid such as propylene carbonate. Alternatively a polymer-based solid electrolyte may be used. A wide variety of intercalation materials are known as cathode materials, such as lithium cobalt oxide, and such materials may be mixed with solid electrolyte material to form a composite cathode. It is also known to use an intercalation material such as graphite as the anode material in place of metallic lithium, and this also may be mixed with a solid electrolyte material to form a composite anode.

Polymer electrolytes comprising a polymer matrix plasticised with a solution of a lithium salt in an organic solvent have also been suggested. For example Gozdz et al (U.S. Pat. No. 5,296,318) described compositions comprising a copolymer of 75 to 92 percent by weight vinylidene fluoride and 8 to 25 percent hexafluoropropylene; this copolymer can be combined with a lithium salt and a plasticising solvent such as ethylene carbonate/propylene carbonate, and cast from a volatile solvent to provide a stable film with adequate electrical conductivity. GB 2 309 703 (AEA Technology) describe an electrolyte comprising a homopolymer polyvinylidene fluoride (PVdF); this polymer can be combined with a salt and a plasticising solvent, and cast from a suitable solvent to produce a good quality electrolyte film. (The homopolymer is characterised by having an exceptionally low melt flow index; melt flow index is a parameter commonly used in specifying plastics materials, and is measured by the method specified in standard ASTM D 1238.)

An alternative approach to making a sheet of electrolyte is to form a porous membrane of such a polymer material, for example using the method of Benzinger et al (U.S. Pat. No. 4,384,047) and then to immerse the porous film in an electrolyte solution comprising a plasticising solvent, for example ethylene carbonate, propylene carbonate and a lithium salt; this procedure is mentioned in WO 98/38687 (Elf Atochem). This process avoids the problems arising from the presence of a hygroscopic lithium salt in the membrane as initially produced, but it is not easy to achieve a polymer film of uniform porosity. Yet another procedure is described by Gozdz et al (WO 95/15589), in which a polymer film is initially cast containing a plasticising solvent (but no salt). This plasticising solvent may be propylene carbonate or ethylene carbonate, but higher-boiling plasticisers such as dibutylphthalate are said to be particularly suitable. Gozdz et al teach that the plasticiser is preferably extracted from the polymer film; subsequently the film is immersed in an electrolyte solution such as ethylene carbonate, propylene carbonate and a lithium salt to produce an electrolyte film. The thinnest such film mentioned by Gozdz et al is 50 μm thick.

According to the present invention there is provided a method of making an electrochemical cell, the method comprising the steps of:

(a) forming a layer comprising a cathodic material into which lithium ions may be reversibly intercalated on a current collector;

(b) forming a layer comprising an anodic material comprising lithium metal, an alloy containing lithium, or a material into which lithium ions may be reversibly intercalated, on a current collector;

(c) forming a plasticised membrane, the membrane being less than 30 μm thick and being cast from a volatile solvent, and comprising a polymeric material consisting of a polymer chain in which the proportion by weight of vinylidene fluoride is at least 85%, and ethylene carbonate as a plasticiser, but containing no lithium salt;

(d) assembling the cathodic layer and the anodic layer separated by at least one such plasticised membrane, so as to form a cell precursor; and

(e) soaking the cell precursor in an electrolyte solution comprising a lithium salt dissolved in a compatible plasticising solvent, so as to form the cell.

The invention also provides an electrochemical cell made by this method.

It will be appreciated that the cell precursor may be formed by laminating the anodic and cathodic layers to the plasticised membranes, and that the layers and the membranes may be wound into a spiral, or folded into a zigzag structure, or merely stacked together. In any event, the cell precursor would normally be enclosed in a rigid housing or a flexible envelope. The electrolyte solution would then be introduced into the housing or the envelope, to be absorbed by the polymeric material, which would form an electrolyte which may be referred to as a solid electrolyte or a gelled electrolyte; the housing or the envelope would then be hermetically sealed.

Preferably the cathodic layer and the anodic layer (if it consists of an intercalation material such as graphite) each also comprise the same polymeric material as in the membrane to act as binder. However, the polymer chain may be different from that in the plasticised membrane, and for example may be a homopolymer of different molecular weight or a grafted copolymer. In one form both the cathodic and anodic layers comprise polymeric material without the presence of ethylene carbonate as a plasticiser, resulting in a porous electrode structure. Alternatively, the cathodic layer and anodic layer may comprise the polymeric material with ethylene carbonate as a plasticiser, but containing no lithium salt. It has been found that ethylene carbonate is not only a satisfactory plasticiser, but that it is compatible with the plasticising solvents used as electrolyte solvents in such lithium cells. The resulting solid electrolyte membrane has high electrical (i.e. ionic) conductivity.

It has also been found that the membranes obtained when casting thicker layers are much less satisfactory, and that the best electrical properties are obtained with layers less than 20 μm thick, more preferably less than 10 μm thick, for example 6 μm. It is believed that the poor electrical properties of thicker layers may arise from a non-uniformity in the distribution of the ethylene carbonate plasticiser within the membrane, and potentially the presence of a surface layer substantially without plasticiser. If a larger thickness of electrolyte is needed in the electric cell, then two or three of the membranes may be stacked or laminated together.

The polymer chain may be a homopolymer polyvinylidene fluoride (PVdF), or may be a copolymer, for example with hexafluoropropylene. The polymer should have a sufficiently high molecular weight to form a mechanically strong polymer film, and so preferably should have a low value of melt flow index. The melt flow index at 230° C. and 10 kg is desirably less than 5.0 g/10 min, and preferably less than 1.0 g/10 min.

It will be appreciated that the volatile solvent must be selected in accordance with the nature of the polymer chain. If the volatile solvent is compatible with the electrolyte solvent (e.g. dimethyl carbonate, DMC), then the plasticised membrane may be cast directly onto the anodic or cathodic layer, whereas if the volatile solvent is not compatible (e.g. dimethyl acetamide, DMA) then the plasticised membrane must first be made as a separate layer and thoroughly dried to remove all traces of the volatile solvent. If there are residual quantities of DMA, then decomposition of this residual DMA at voltages above 4 V may be a factor in causing capacity decline on cycling in cells containing lithium cobalt oxide composite cathodes.

The invention will now be further and more particularly described, by way of example only, with reference to the following Examples and with reference to the accompanying drawing which shows graphically the variation of voltage with cell capacity, during discharge at different currents, for a cell of the invention.

### EXAMPLE 1

### Plasticised Membrane Production—DMC Cast Film

The following components were mixed together and warmed. The polymer is a co-polymer of vinylidene fluoride (VdF) and hexafluoropropylene (HFP) containing 6% HFP, that has a melt flow index at 230° C. of 2.8 g/10 min at 21.6 kg. The quantities are given in parts by weight:

7.5 parts PVdF/6%HFP

30 parts ethylene carbonate

39 parts dimethyl carbonate (DMC)

The resulting solution was then coated onto a carrier foil at a web speed of 2.0 m/min, using a doctor blade over a roller with a blade gap of 0.06 mm and dried in the presence of an air stream while passing through successive drying zones at 55° C. and 70° C., to ensure evaporation of the DMC. The resulting plasticised membrane, removed from the foil, was of thickness 8 μm.

### EXAMPLE 2

### Plasticised Membrane Production—DMC Cast Film

The following components were mixed together and warmed. The polymer is a co-polymer of vinylidene fluoride (VdF) and hexafluoropropylene (HFP) containing 6% HFP which has a melt flow index at 230° C. of 2.8 g/10 min at 21.6 kg. The quantities are given in parts by weight:

5 parts PVdF/6%HFP

5 parts ethylene carbonate

42 parts dimethyl carbonate (DMC)

The resulting solution was then coated onto a carrier foil at a web speed of 2.0 m/min, using a doctor blade over a roller with a blade gap of 0.1 mm, and dried in the presence of an air stream while passing through successive drying zones at 70° C. and 100° C. The resulting film was subjected to vacuum drying for 16 hours at 70° C. The resulting plasticised membrane, removed from the foil, was of thickness 4 μm.

### EXAMPLE 3

### Plasticised Membrane Production—DMA Cast

The following components were mixed together and warmed. The polymer is a homopolymer of vinylidene fluoride (PVdF) of the type Solef 1015 (Solef is a trade mark of Solvay Chemicals Ltd.) which has a melt flow index at 230° C. of 0.7 g/10 min at 10 kg, and 0.2 g/10 min at 5 kg. The quantities are given in parts by weight:

10 parts PVdF

10 parts ethylene carbonate

70 parts dimethyl acetamide (DMA)

The resulting solution was then coated onto a carrier foil at a web speed of 1.0 m/min, using a doctor blade over a roller with a blade gap of 0.1 mm, and dried in the presence of an air stream while passing through successive drying zones at 70° C. and 100° C. The resulting film was subjected to vacuum drying for 16 hours at 60° C. to ensure the evaporation of all the DMA. The resulting plasticised membrane, removed from the foil, was of thickness 6 μm.

Electrode Production

A cathode is made by mixing lithium cobalt oxide, carbon, homopolymer PVdF (as a binder) and N-methyl pyrrolidone (NMP) as solvent, casting onto an aluminium foil current collector, and evaporating the NMP. An anode is made by a similar process, mixing mesocarbon microbeads of particle size 10 μm (which had been heat treated at 2800° C.) with graphite powder, and homopolymer PVdF as binder, and NMP as solvent; casting the mixture onto a copper foil current collector; and evaporating the NMP. In both cases the resulting cast material contains some porosity.

Cell Assembly

A cell precursor was made by winding a cathode and an anode, separated by two plasticised membranes as described above, into a flat spiral. This spiral assembly was inserted into a flexible packaging. The assembly was vacuum filled with a plasticising liquid electrolyte: 1.2 molar LiPF₆ in a mixture of ethylene carbonate and ethyl methyl carbonate. After storing for 16 hours to ensure the electrolyte had been absorbed by all the cell components, the packaging was vacuum sealed.

It will be appreciated that cells may be made in various ways falling within the scope of the invention, differing from those described above. For example the spiral assembly of the cathode, the anode and the plasticised membranes as described above might be enclosed in a stainless-steel casing, and vacuum filled with the plasticising liquid electrolyte. After filling the casing would be sealed.

In addition, a cell precursor may be made by laminating, through heated rollers, a cathode and an anode as described above, separated by two plasticised membranes as described above.

An alternative plasticised membrane might be made using a copolymer, for example containing 94 parts by weight vinylidene fluoride and 6 parts by weight hexafluoropropylene (PVdF/6HFP). The solution of this copolymer, along with say 4 times as much ethylene carbonate, might be cast from a solvent such as dimethyl carbonate. This boils at about 88° C., so that it can be readily evaporated in a dryer. Furthermore, it is compatible with the plasticising liquid electrolyte, so that the plasticised membrane may be cast directly onto the anode layer and/or the cathode layer.

Cell Testing

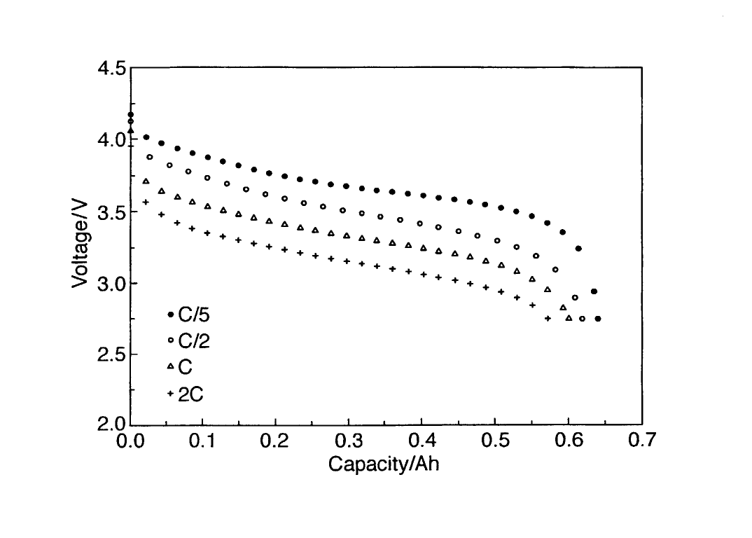

Each cell was subjected to repeated charge and discharge cycles. The rated capacity of each cell was initially measured by charging and then discharging a few times at a current of 120 mA (that is to say at the C/5 rate, assuming the capacity is 0.6 Ah). The discharge behaviour at different discharge currents was then observed. Referring to FIG. 1, this shows subsequent discharge graphs for one such cell at different discharge currents, each graph showing the variation in cell voltage against the total charge withdrawn from the cell during that discharge; in this case the cell contained two membranes cast from DMA as in Example 3. It will be observed that the smaller the discharge current, the more charge can be obtained from the cell. At a discharge current numerically equal to a fifth of the rated cell capacity (i.e. C/5) the capacity available from the cell is 0.635 Ah, whereas at a discharge current numerically equal to the rated cell capacity (i.e. C) the available capacity is about 0.60 Ah. In addiction, the larger the discharge current, the lower is the cell voltage.

One such cell, containing two membranes cast from DMA as in Example 3, has been subjected to over 95 successive charge and discharge cycles at the C/5 rate. The capacity decreased only very slightly, from about 0.66 Ah to about 0.61 Ah, over those cycles. The cell is expected to cycle similarly for as many as 300 cycles.

1. A method of making an electrochemical cell, the method comprising the steps of:
(a) forming a layer comprising a cathodic material into which lithium ions may be reversibly intercalated on a current collector;
(b) forming a layer comprising an anodic material comprising lithium metal, an alloy containing lithium, or a material into which lithium ions may be reversibly intercalated, on a current collector;
(c) forming a plasticised membrane, the membrane being less than 30 μm thick and being cast from a volatile solvent, and comprising a polymeric material consisting of a polymer chain in which the proportion by weight of vinylidene fluoride is at least 85%, and ethylene carbonate as a plasticiser, but containing no lithium salt;
(d) assembling the cathodic layer and the anodic layer separated by at least one such plasticised membrane, so as to form a cell precursor; and
(e) soaking the cell precursor in an electrolyte solution comprising a lithium salt dissolved in a compatible plasticising solvent, so as to form the cell.

2. A method as claimed in claim 1 in which the cell is enclosed in a rigid housing or a flexible envelope before soaking in electrolyte solution, and wherein, after introducing the electrolyte solution into the housing or envelope, the housing or the envelope is then hermetically sealed.

3. A method as claimed in claim 1 or claim 2 wherein the membrane is less than 10 μm thick.

4. A method as claimed in any one of the preceding claims wherein the proportion of ethylene carbonate in the plasticised membrane is at least 30% by weight.

5. A cell made by a method as claimed in any one of the previous claims.

6. A cell as claimed in claim 5 wherein both the cathodic and anodic layers comprise polymeric material without the presence of ethylene carbonate as a plasticiser.

7. A cell as claimed in claim 5 wherein both the cathodic layer and anodic layer comprise the polymeric material with ethylene carbonate as a plasticiser, but containing no lithium salt.
